(19) United States
(12) Patent Application Publication
(10) Pub. No.: US 2013/0141677 A1
(43) Pub. Date: Jun. 6, 2013

(54) LCD, LCD Substrate and LCD Manufacturing Method

(71) Applicants: Hongjie Wu, Guangdong (CN); Bing-jei Liao, Guangdong (CN); Hsiang-yin Shih, Guangdong (CN); Cheng-chuan Chan, Guangdong (CN)

(72) Inventors: Hongjie Wu, Guangdong (CN); Bing-jei Liao, Guangdong (CN); Hsiang-yin Shih, Guangdong (CN); Cheng-chuan Chan, Guangdong (CN)

(21) Appl. No.: 13/378,750

(22) PCT Filed: Dec. 7, 2011
(86) PCT No.: PCT/CN11/83638

§ 371 Date: Dec. 16, 2011

(30) Foreign Application Priority Data
Dec. 2, 2011 (CN) 2011103963159

(51) Int. Cl. G02F 1/1335; H01J 9/26; H01J 9/00; G02F 1/1333; G02F 1/1339

(52) U.S. Cl. 349/106; 349/158; 349/153; 445/24; 445/25

(57) ABSTRACT

The present invention discloses a Liquid Crystal Display (LCD), a LCD substrate and a LCD manufacturing method. The boundary of the substrate, to be coated with alignment liquid, is provided with a boss or a groove which is used to prevent the alignment liquid from diffusing. Because the substrate of the LCD is provided with the boss or groove for preventing the alignment liquid from diffusing, the boss can prevent the alignment liquid from diffusing, and the groove can absorb the diffused alignment liquid. As a result, the alignment liquid is prevented from forming nonuniform boundary on the substrate with surface section difference, and the uniform boundary is formed; furthermore, the boundary of the active area of the LCD further deflects to the alignment layer, and the range of the active area is expanded. Under the action of the blockage by the boss or groove, the boss or groove can deflect to the sealant area, i.e. the boundary of the alignment layer deflects to the sealant area, thereby further expanding the range of the active area.

### TECHNICAL FIELD

The present invention relates to the field of liquid crystal displays, in particular to a Liquid Crystal Display (LCD) substrate, a LCD and a LCD manufacturing method.

### BACKGROUND

The LCD panel is the main component of LCD, and includes a top array substrate, a color film substrate and liquid crystals, wherein the liquid crystals are arranged between the array substrate and the color film substrate, and aligned by the alignment layer which is coated on the substrate, so that the liquid crystals can be arranged in the specified direction.

FIG. 1 shows the alignment layer coating technology of the glass substrate of existing liquid crystal panel. As the alignment liquid (PI) would diffuse under the action of surface tension, and the surface of the edge of the glass substrate is not uniform or flat, the alignment liquid would be nonuniformly distributed on the edge of the substrate due to the influence by section difference between the circuits of array substrate and the section difference between the surfaces of Black Matrix (BM) of color film substrate, and even exceed the size of coating precision. As shown in FIG. 1, the alignment liquid should be uniformly diffused under ideal condition; however, under actual condition, the alignment liquid is nonuniformly diffused and would form a complex curve boundary.

FIG. 2 shows the cross section of the local edge of the existing LCD panel made by the coating technology in FIG. 1, and the LCD panel includes a color film substrate and an array substrate, wherein the color film substrate has a top plate 10, and a top electrode 30 is arranged on the top plate 10; the array substrate has a bottom plate 20, and a bottom electrode 40 is arranged on the bottom plate 20; and an alignment layer 50 is coated on the top plate 10 and the bottom plate 20. In FIG. 1, the line from A to A′ represents the active edge 101 of the active area; the line from B to B′ represents the alignment edge 51 of the alignment layer 50. Under the influence by the nonuniform diffusion of alignment layer through coating technology, the coating edge of the alignment layer 50 would generate the limitations of nonuniform diffusion, etc. (as shown in FIG. 1). Therefore, a space X must be kept between the active edge 101 and the alignment edge 51; or else, the edges in the active area are easy to form poor liquid crystal alignment or nonuniform display (mura) and the like.

In addition, as the alignment liquid forms the nonuniform diffusion on the coating boundary, the space X should be kept between the coating boundary and the active edge 101, and a gap should be remained between the coating boundary and the setting area of sealant 60, so as to avoid the phenomena that the alignment liquid diffuse to the setting area of sealant 60; the attachment of sealant 60 is poor; and the golden ball particles 70 cannot transmit the signal of the array substrate to the color film substrate in a timely way. Due to these factors, the coating boundary of alignment liquid is severely affected, and the display range of LCD is further affected.

### SUMMARY

The present invention aims to provide a LCD, a LCD substrate and a LCD manufacturing method, wherein the LCD substrate has good alignment liquid coating effect and narrow frame.

The purpose of the present invention is achieved by the following technical schemes: a LCD substrate, wherein the boundary of the substrate area, to be coated with alignment liquid, is provided with a boss or a groove which is used to prevent the alignment liquid from diffusing.

Preferably, the substrate is an array substrate, the array substrate has a pixel electrode layer which is formed on the surface, and the boss is formed on the pixel electrode layer. If the pixel electrode layer of the array substrate is arranged under the alignment layer, the boss can be formed on the pixel electrode layer, thus preventing the alignment liquid from diffusing.

Preferably, the substrate is an array substrate; the array substrate comprises a passive film which is formed on the surface; and the groove is formed on the passive film

Preferably, the height of the boss is greater than the thickness of the alignment liquid, thus preventing the alignment liquid from diffusing out over the boss.

Preferably, the substrate is an array substrate, the array substrate has a pixel electrode layer which is formed on the surface, and the groove is formed on the upper surface of the pixel electrode layer. According to different structures and different technological requirements, the groove is arranged on the applicable film, so as to reach the optimum production efficiency and least product cost.

Preferably, the substrate is an array substrate, the array substrate has a passive film which is formed on the surface, and the groove is formed on the passive film. According to the structure and technological requirements of the array substrate, the groove is arranged on the passive layer, so as to reach the optimum production efficiency and least product cost.

Preferably, the substrate is a color film substrate, the color film substrate has a black matrix which is formed on the surface, and the groove is formed on the upper surface of the black matrix. According to the structure and technological requirements of the color film substrate, the groove is arranged on the black matrix, so as to reach the optimum production efficiency and less product cost.

Preferably, the substrate is a color film substrate, and the boss is formed by the gap particles arranged on the coating boundary of the alignment liquid. Utilizing the gap particles to form the boss can save the deposition procedure or the etching procedure.

Preferably, the boss is a sealant which is arranged on the boundary of the color film substrate or array substrate to be coated with alignment liquid. The method by coating sealant is convenient and rapid.

A LCD has said LCD substrate.

A LCD manufacturing methods includes the following steps:

Step A: Form a boss or a groove on the boundary of substrate to be coated with alignment liquid.

Step B: Coat the alignment liquid.

Preferably, in step A, the substrate is an array substrate of LCD, and the boss is formed on the pixel electrode layer of the array substrate. According to the bottom of array substrate to be coated with alignment liquid, a boss is deposited on the electrode surface, so as to prevent the alignment liquid from diffusing.

Preferably, in step A, the substrate is an array substrate, the array substrate has a passive film which is formed on the surface, and the boss is formed on the passive film. For the array substrate with a passive film, according to the structure and technological requirements, a boss is deposited on the passive layer, so as to reach the optimum production efficiency, less production cost and better panel structure.

Preferably, in step A, the substrate is a color film substrate, and the boss is formed by the gap particles arranged on the coating boundary of the alignment liquid, so that one procedure can be saved.

Preferably, in step A, the substrate is an array substrate, the array substrate has a pixel electrode layer which is formed on the surface, and the groove is formed on the upper surface of the pixel electrode layer. According to the bottom of array substrate to be coated with alignment liquid, a groove is etched on the electrode surface, so as to prevent the alignment liquid from diffusing.

Preferably, in step A, the substrate is a color film substrate of LCD, and the groove is formed on the surface of the black matrix layer of the color film substrate. For the color film substrate, the groove can be formed on the surface of the black matrix.

Preferably, the groove is formed by the exposure machine through a photoetching method. The groove can be formed by the exposure machine through a photoetching method.

Preferably, in step A, the boss is a sealant which is arranged on the boundary of the color film substrate or array substrate to be coated with alignment liquid. The method by coating sealant is simple, rapid and low-cost.

As the LCD substrate is provided with the boss or groove for preventing the alignment liquid from diffusing, the boss can prevent the alignment liquid from diffusing, and the groove can absorb the diffused alignment liquid to prevent the alignment liquid form diffusing. As a result, the alignment liquid is prevented from diffusing on the substrate of uneven surface and forming uniform boundary, an uniform boundary is formed, and the alignment effect of the boundary of alignment liquid meet the requirement; furthermore, the boundary of the active area of the LCD can deflect to the boundary of the alignment layer, and the range of the active area is expanded. Under the action of blockage by the boss or groove, the alignment liquid, when flowing to the setting area of sealant, cannot cause unreliable attachment of sealant or unreliable conductivity of golden ball, so that the boss or groove can deflect to the sealant area, i.e. the boundary of alignment layer deflects to the sealant area, and then the range of active area is further expanded.

### DESCRIPTION OF FIGURES

FIG. 1 is the practical and ideal conditions of the alignment liquid coating technology of the existing LCD panels.

FIG. 2 is the section of existing LCD panels.

FIG. 3 is the section of LCD panel of the embodiment of the present invention.

FIG. 4 is the schematic for illustrating the boss preventing the alignment liquid in the embodiment of the present invention.

FIG. 5 is the schematic for illustrating the groove preventing the alignment liquid in the embodiment of the present invention.

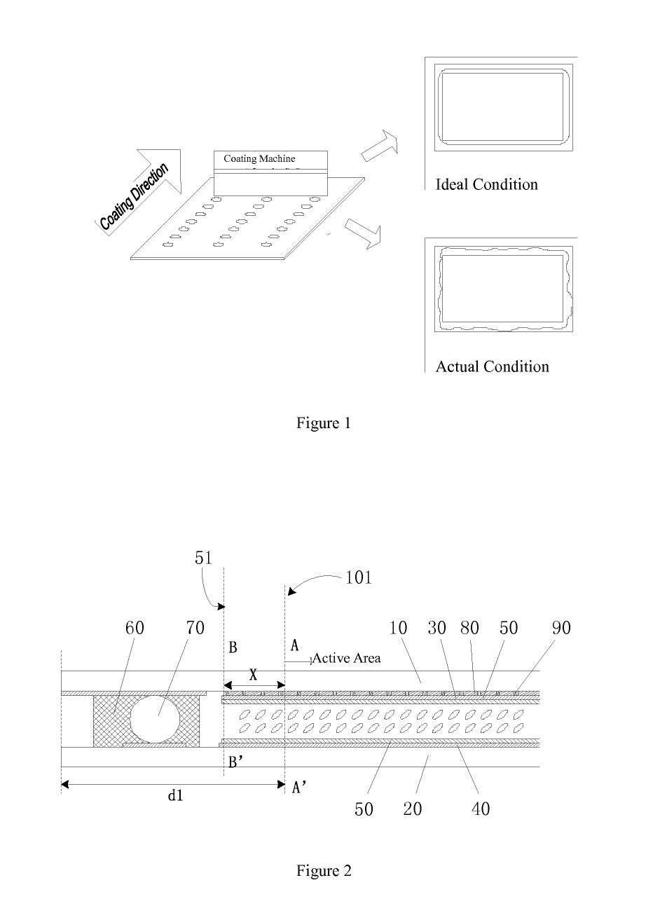

Wherein: 10. top plate, 20. bottom plate, 30. top electrode, 40. bottom electrode, 50. alignment layer, 51. boundary of alignment layer, 54. groove, 55. boss, 60. sealant, 70. golden ball, 80. color film, 90. black matrix, and 101. boundary of active area.

### DETAILED DESCRIPTION

The present invention is further described by figures and the preferred embodiments as follows.

The present invention provides a LCD and a LCD manufacturing method. The LCD has a substrate, wherein the boundary of the substrate, to be coated with alignment liquid, is provided with a boss or a groove for preventing the alignment liquid from diffusing. The substrate includes an array substrate and a color film substrate.

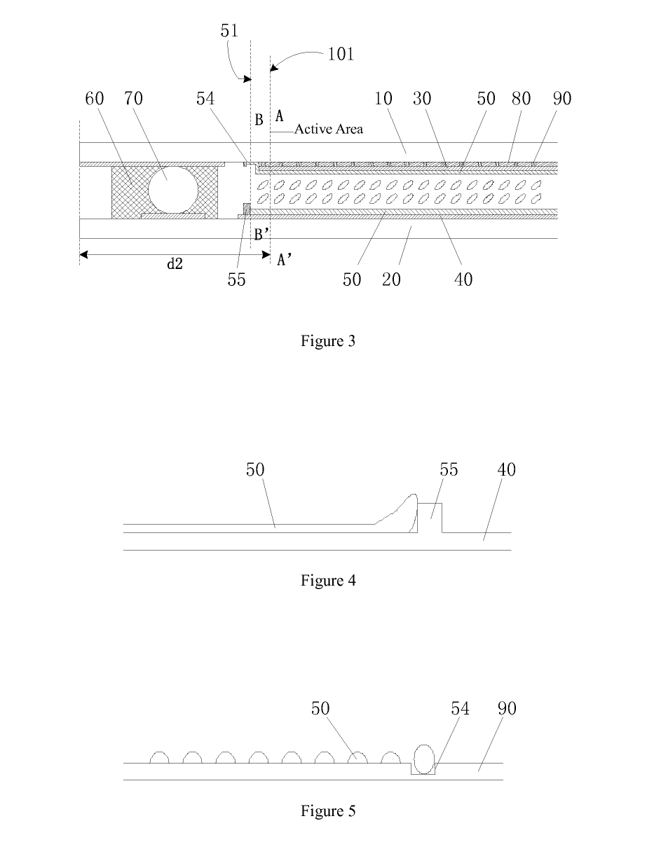

The FIG. 3 is the embodiment of the prevent invention, and shows a structure section of LCD panel. The LCD includes an array substrate and a color film substrate, wherein the color film substrate has a top plate 10; a color film 80, a black matrix 90 and a top electrode 30 (i.e. share electrode) are arranged on the top plate 10, and the top electrode 30 is arranged on the upper surfaces of the color film 80 and black matrix 90; the array substrate has a bottom plate 20; a bottom electrode 40 (i.e. pixel electrode) is arranged on the bottom plate 20, and an alignment layer is coated on the upper surfaces of the top electrode 30 and bottom electrode 40. As shown in FIG. 3 and FIG. 4, on the array substrate, the boss 55 is arranged on the upper surface of the bottom electrode 40, at the boundary 51 of the alignment layer (refer to BB′), and used to prevent the alignment liquid from diffusing when the alignment liquid is coated on the array substrate, thus forming a good and uniform boundary of alignment layer on the array substrate. As shown in FIG. 3 and FIG. 5, on the color film substrate, the groove 54 is arranged on the upper surface of the black matrix 90, at the boundary 51 of the alignment layer. Therefore, when the alignment liquid is coated on the color film substrate, the groove 54 can absorb the diffused alignment liquid, and the alignment liquid cannot further diffuse out, thus forming a good and uniform boundary of alignment layer on the color film substrate. As the uniformity of the boundary of alignment layer is improved, the alignment effect is satisfactory at the boundary, and the boundary of active area deflects to the boundary of alignment layer so as to reduce the frame width of the LCD panel. Under the action of blockage by the boss or groove, the alignment liquid, when flowing to the setting area of sealant, cannot cause unreliable attachment of sealant, so that the boss or groove can deflect to the sealant area, i.e. the boundary of alignment layer deflects to the sealant area, the range of active area is further expanded, and the width of the frame of LCD panel is further reduced. In FIG. 3, when the width d2 of the LCD panel in this embodiment compared with the width d1 of the existing panel with same size, d2 is less than d1, i.e. the LCD panel in this embodiment is narrower than the frame of the existing LCD panel.

Under the existence of the surface tension of alignment liquid, even if the height of the boss is equal to or smaller than the thickness of the alignment liquid, the alignment liquid can be prevented from diffusing out over the boss at some extent. If the height of the boss is greater than the thickness of the alignment liquid, the alignment liquid can be better prevented from diffusing out over the boss.

In the present invention, different LCD panels have different structures. For example, for the LCD panel with FFS structure and the LCD panel with COA structure, the film distributions on the substrates are different, and then the boss or groove is designed on the applicable film according to different LCD panels and different technological processes, so as to simplify the production process of the LCD panel, enhance the efficiency of LCD panels, and ensure the optimum display effect of the LCD panels. For example, a boss is formed on the passive film of the array substrate; a groove is formed on the upper surface of the pixel electrode layer of the array substrate; a groove is formed on the passive film of the array substrate; a groove is formed on the upper surface of the black matrix of the color film substrate; and the gap particles on the color film substrate are used to form a gap particle wall which can block the alignment liquid, or the sealant is coated around the substrate to form a sealant wall. The boss and groove may not be formed on the film adjacent to the alignment layer, for example, on the color film substrate, firstly, the groove is formed on the black matrix, and then the groove would naturally exist on the electrode when the electrode is formed.

In the present invention, the LCD manufacturing method has the following steps:

Step A: Form a boss or a groove on the boundary of the substrate to be coated with the alignment liquid.

Step B: Coat the alignment liquid.

For example, when the boss is arranged in the array substrate, in step A, after the pixel electrode layer is deposited on the array substrate, a resin solvent is deposited to a boss on the boundary of array substrate to be coated with alignment liquid.

For example, when a groove is arranged in the color film substrate, in step A, after the black matrix is deposited in the color film substrate, a groove is formed by the exposure machine through a photoetching method on the black matrix layer.

The present invention is described in detail in accordance with the above contents with the specific preferred embodiments. However, this invention is not limited to the specific embodiments. For the ordinary technical personnel of the technical field of the present invention, on the premise of keeping the concept of the present invention, the technical personnel can also make simple deductions or replacements, and all of which should be considered to belong to the protection scope of the present invention.

We claim:

1. A LCD substrate is provided with a boss or a groove which is used to prevent the alignment liquid from diffusing at the boundary of the substrate to be coated with alignment liquid.

2. The LCD substrate of claim 1, wherein said substrate is an array substrate; the array substrate comprises a pixel electrode layer which is formed on the surface; and the boss is formed on the pixel electrode layer.

3. The LCD substrate of claim 1, wherein said substrate is an array substrate; the array substrate comprises a passive film which is formed on the surface; and the boss is formed on the passive film.

4. The LCD substrate of claim 1, wherein the height of the boss is greater than the thickness of the alignment liquid.

5. The LCD substrate of claim 1, wherein said substrate is an array substrate; the array substrate comprises a pixel electrode layer which is formed on the surface; and the groove is formed on the upper surface of the pixel electrode layer.

6. The LCD substrate of claim 1, wherein said substrate is an array substrate; the array substrate comprises a passive film which is formed on the surface; and the groove is formed on the passive film.

7. The LCD substrate of claim 1, wherein said substrate is a color film substrate; the color film substrate comprises a black matrix which is formed on the surface; and the groove is formed on the upper surface of the black matrix.

8. The LCD substrate of claim 1, wherein said substrate is a color film substrate; the boss is formed by gap particles which are distributed on the coating boundary of the alignment liquid.

9. The LCD substrate of claim 1, wherein the boss is a sealant which is arranged on the boundary of the color film substrate or array substrate to be coated with alignment liquid.

10. A LCD, comprising said LCD substrate of claim 1, wherein the boundary of the substrate, to be coated with alignment liquid, is provided with a boss or a groove which is used to prevent the alignment liquid from diffusing.

11. A LCD manufacturing method includes the following steps:
Step A: Form a boss or a groove on the boundary of the substrate to be coated with the alignment liquid.
Step B: Apply the alignment liquid.

12. The LCD manufacturing method of claim 11, wherein in step A, the substrate is an array substrate; the boss is formed on the pixel electrode layer of the array substrate.

13. The LCD manufacturing method of claim 11, wherein in step A, the substrate is an array substrate; the array substrate comprises a passive film which is formed on the surface; and the boss is formed on the passive film.

14. The LCD manufacturing method of claim 11, wherein in step A, the substrate is a color film substrate; the boss is formed by gap particles which are distributed on the boundary of the alignment liquid.

15. The LCD manufacturing method of claim 11, wherein in step A, the substrate is an array substrate; the array substrate comprises a pixel electrode layer which is formed on the surface; and the groove is formed on the upper surface of the pixel electrode layer.

16. The LCD manufacturing method of claim 11, wherein in step A, the substrate is a color film substrate; the groove is formed on the black matrix layer of the color film substrate.

17. The LCD manufacturing method of claim 11, wherein the groove is formed by photoetching via an exposure machine.

18. The LCD manufacturing method of claim 11, wherein in step A, the boss is a sealant which is arranged on the boundary of the color film substrate or array substrate to be coated with alignment liquid.

19. The LCD of claim 10, wherein the substrate is an array substrate; the array substrate comprises a pixel electrode layer which is formed on the surface; and the boss is formed on the pixel electrode layer.

20. The LCD of claim 10, wherein the substrate is an array substrate; the array substrate comprises a passive film which is formed on the surface; and the boss is formed on the passive film.

21. The LCD of claim 10, wherein the height of the boss is greater than the thickness of the alignment liquid.

22. The LCD of claim 10, wherein the substrate is an array substrate; the array substrate comprises a pixel electrode layer which is formed on the surface; and the groove is formed on the upper surface of the pixel electrode layer.

23. The LCD of claim 10, wherein the substrate is an array substrate; the array substrate comprises a passive film which is formed on the surface; and the groove is formed on the passive film.

24. The LCD of claim 10, wherein the substrate is a color film substrate; the color film substrate comprises a black matrix which is formed on the surface; and the groove is formed on the upper surface of the black matrix.

25. The LCD of claim 10, wherein the substrate is a color film substrate; the boss is formed by gap particles which are distributed on the boundary of the alignment liquid.

26. The LCD of claim 10, wherein the boss is a sealant which is arranged on the boundary of the color film substrate or array substrate to be coated with alignment liquid.
